(19) United States
(12) Patent Application Publication
(10) Pub. No.: US 2006/0000389 A1
(43) Pub. Date: Jan. 5, 2006

(54) Pigment compositions comprising aluminium metal particles

(75) Inventors: Etienne Duguet, Begles (FR); Fabrice Morvan, Oloron Ste Marie (FR); Herve Lelievre, Estialescq (FR)

Correspondence Address: YOUNG & THOMPSON, 745 SOUTH 23RD STREET, 2ND FLOOR, ARLINGTON, VA, 22202, US

(73) Assignee: TOYAL EUROPE SA, BEDOUS (FR)

(21) Appl. No.: 10/530,206

(22) PCT Filed: Oct. 2, 2003
(86) PCT No.: PCT/FR03/02897

§ 371 Date: Apr. 4, 2005

(30) Foreign Application Priority Data
Oct. 3, 2002 (FR) 02/12273

(51) Int. Cl. B32B 15/02; B32B 5/16; B05D 7/00

(52) U.S. Cl. 106/404; 428/403; 427/212

(57) ABSTRACT

A pigment composition contains aluminium metal-based particles (p), the particles (p) including a surface oxidation layer having an average thickness of at least 5 nm. In addition, the aforementioned particles (p) are coated with a protective layer having hydrocarbon chains R which are linked to the surface of the particles (p) by [particle]-Al—O—Si—R linkages. The invention also relates to method of preparing the inventive pigment compositions as well as the use thereof, in particular, for the formulation of water-based metallic paints.

The present invention relates to pigment compositions based on aluminum metal particles, especially intended for the formation of so-called “metallic” paints, and in particular of water-based paints as used e.g. in the context of the automobile industry.

As a general rule, the pigment compositions based on aluminum metal particles which are currently known are obtained by “wet milling” processes, which consist in introducing, into a device of ball mill type, (1) aluminum (generally in a powder form, this powder being generally obtained by atomization, namely by cooling sprayed liquid aluminum into a stream of air or of inert gas); (2) a fatty acid (for example, oleic acid or stearic acid); and (3) an aliphatic solvent or a mixture of aliphatic solvents (generally a mixture of white spirit type).

Following this plastic deformation in the presence of fatty acid and of solvent(s), a paste is obtained comprising aluminum in the form of flakes (so-called “lamellar pigments”), at the surface of which molecules of fatty acids are adsorbed. It is hypothesized that, in the scope of this process, the joint use of the fatty acids and of the solvents makes it possible both to prevent cold welding of the aluminum particles during their plastic deformation and to momentarily protect the particles, with regard to oxidation, in particular by the ambient air and/or by moisture.

A typical example of a “wet milling” process is disclosed in patent U.S. Pat. No. 2,002,891. This process, known under the name of “Hall process”, is currently the commonest industrial process for producing pigment compositions of aluminum in the form of flakes. Over the years, the various parameters to be adjusted in order to obtain various grades of pigments, with a given shape, a given size and given properties, have been developed. Thus, for example, the influence of the initial particle size of the aluminum powder, of the milling time and speed, of the diameter of the balls or of the type of mill employed have been studied. For further details on this subject, reference may be made in particular to patents U.S. Pat. No. 3,901,688, U.S. Pat. No. 3,970,577, U.S. Pat. No. 3,901,688, U.S. Pat. No. 4,236,934 or U.S. Pat. No. 4,693,754, or to application EP 305 158.

More generally, the Hall process and analogous processes today emerge as industrial processes which are relatively easy to operate, insofar as their optimum operating conditions are now well established, both in terms of effectiveness and of safety. In addition, these processes make it possible to obtain aluminum pigments possessing the targeted properties, in a simple, effective, and relatively inexpensive way.

However, despite these various advantages, it turns out that the potential applications of the aluminum metal pigments obtained by the Hall-type processes are limited to uses in compositions based on organic solvents, essentially in paint compositions based on organic solvents. This is because, in the presence of water, these pigments rapidly corrode, which generally results in an at least partial loss in their metallic lustre (especially by formation, at their surface, of a thick layer of oxide) and above all by a significant release of hydrogen, which can in particular cause problems in terms of safety (inflammability, or even explosivity; overpressure in the storage barrels, etc.).

Now, at the present time, due to legal changes targeted at reducing the use of organic solvents, a search is underway specifically to develop, in the field of metallic or nonmetallic paints, water-based compositions (so-called “waterborne” formulations). The pigments of the type obtained according to the Hall process clearly appear to be unsuitable in such waterborne formulations.

Consequently, in recent years, strenuous attempts have been made to modify the pigments obtained according to the Hall process, so as to render them suitable for an use in an aqueous medium.

To date, the attempts made in this context have essentially consisted in modifying the surface of the particles obtained by the Hall-type processes, this modification consisting in replacing the adsorbed molecules of fatty acids by corrosion-inhibiting entities, such as phosphoric esters, phosphates, phosphonates, vanadates, chromates, molybdates or alternatively rare-earth metal salts or dimer acids. The desorption of the molecules of fatty acids and the adsorption of the inhibiting entities necessary in this process generally result in extensive stages which especially have to be carried out in the absence of oxygen and of moisture, especially to prevent as far as possible oxidation of the aluminum flakes during these stages. Another route has consisted in attempting to carry out an encapsulation in a polymer or silica shell, which requires rigorous control of the experimental conditions, especially to prevent phenomena of agglomeration and to retain the morphology of the starting particle.

In all cases, the processes developed have thus proved to be expensive and, generally, difficult to operate at the industrial level. In addition, pigment compositions comprising aluminum metal which are obtained according to these processes generally prove to be disappointing in terms of resistance to corrosion. Moreover, their optical properties are generally mediocre in comparison with those of the pigment compositions obtained directly on conclusion of the Hall-type processes. This phenomenon is generally attributed to the relatively great thickness of the surface oxide layer, generally much greater than 6 nm (generally at least of the order of 7 to 10 nm).

Now, entirely unexpectedly, the inventors have discovered that it is possible to make use, in a plastic deformation process such as the “milling” of the conventional “Hall” method, not fatty acids but specific compounds, of silane type, which results in the formation of aluminum pigment compositions exhibiting optical properties at least comparable to those of the compositions obtained according to the Hall-type processes, and which additionally exhibit very good resistance to corrosion, especially with regard to water.

Furthermore, the studies of the inventors have evidenced that the pigment compositions obtained in this context are, surprisingly, suitable both for waterborne formulations and for formulations based on organic solvents.

Moreover, the inventors have also discovered that, surprisingly, the processing conditions during a milling with a compounds of silane type can be modeled on the conditions drawn up for the conventional Hall-type processes.

On the basis of these discoveries, one aim of the invention is to provide pigment compositions exhibiting optical properties at least comparable to those of the pigment compositions obtained according to the conventional Hall-type processes, and further having an increased resistance to corrosion. In this context, a particular aim of the invention is to provide pigment compositions comprising aluminum metal, which can be used in particular in an aqueous medium, in which the aluminum particles exhibit high stability with regard to oxidation and corrosion.

Another aim of the invention is to provide pigment compositions comprising aluminum metal capable of being able to be used both in an aqueous medium and in an organic solvent medium.

More generally, another aim of the invention is to provide a simple, effective and inexpensive process which makes it possible to prepare particles of aluminum metal which are stabilized with regard to oxidation and corrosion by water and air.

Thus, according to a first aspect, a subject matter of the present invention is a pigment composition comprising particles (p) based on aluminum metal, said particles (p) having a surface oxidation layer with a mean thickness at most equal to 5 nm, and said particles (p) being covered with a protective layer comprising hydrocarbon chains R bonded to the surface of the particles (p) via [particle]-Al—O—Si—R bonds.

The term “particles based on aluminum metal” is understood to mean, within the meaning of the present invention, particles comprising aluminum in the metallic state. In these particles, the total amount of elemental aluminum present preferably represents at least 50% by weight, advantageously at least 70% by weight and more preferably still at least 90% by weight, with respect to the amount of metal elements present in said particles. Furthermore, in particles based on aluminum metal according to the invention, it is generally preferable for the amount of aluminum in the metallic state to represent at least 90% of the total amount of aluminum (advantageously at least 95% and more preferably still at least 98% and particularly advantageously at least 99%, indeed even at least 99.5%). In a particularly preferred way, the particles employed in the invention are particles essentially based on aluminum metal, that is to say particles composed to at least 99.5% by weight (preferably at least 99.7% by weight and more preferably still at least 99.9% by weight) of aluminum in the metallic state.

Generally, the particles (p) present in the compositions of the invention are anisotropic particles with mean dimensions of less than or equal to 500 microns, preferably of less than 400 microns and advantageously of less than 300 microns.

Thus, generally, the particles (p) are particles of flake type, with a mean transverse diameter of less than or equal to 500 microns, preferably between 1 and 400 microns, more preferentially between 2 and 250 microns and advantageously between 5 and 100 microns, and with a mean thickness of less than or equal to 3 microns and preferentially of between 0.1 and 2 microns. Generally, the aspect ratio of the particles (p) (ratio of the mean thickness to the mean transverse diameter) is between ⅕ and 1/1000 and preferably between 1/10 and 1/100.

Furthermore, whatever their exact morphology, the particles (p) present in the pigment compositions of the invention generally have a specific surface of between 0.5 and 500 m²/g, this specific surface advantageously being between 1 and 10 m²/g and preferably of the order of 5 m²/g.

Characteristically, particles (p) present in the compositions of the invention exhibit a surface oxidation layer with a mean thickness at most equal to 5 nm, it being possible for this thickness of the surface oxidation layer to be less than 4 nm in some cases.

The thickness of the surface oxidation layer to which reference is made herein may e.g. be measured by Auger electron spectroscopy, according to a conventional method, which consists in establishing the chemical composition at the surface of the pigments studied, and then in performing ion etching of the surface, allowing access to the deeper “layers”, thereby making it possible to analyze the various surfaces step by step. The establishment of the concentration profile of the various chemicals (aluminum and oxygen in the present case) as a function of the depth makes it possible to evaluate the thickness of the oxide layer. This technique, commonly used by the operators of Auger electron spectroscopy devices, generally makes it possible to obtain an accuracy of the order of a nanometer for the measurement of the thickness of the surface oxidation layer.

Independently from any specific theory, it is hypothesized that the low oxidation layer thickness of the particles (p) induces good optical qualities for the pigment compositions of the invention, in particular as regards the brilliance and the metallic lustre. In any case, the pigment compositions of the invention generally exhibit brilliance characteristics at least similar to those of the usual commercial compositions obtained according to the Hall process.

An essential characteristic of the particles (p) present in the compositions of the invention is the specific presence at the surface of a protective layer comprising hydrocarbon chains R.

The term “protective layer” is understood to mean, within the meaning of the present description, an organic layer entirely covering the particles (p) and providing protection of the aluminum metal with regard to corrosion and/or oxidation and preferably both with regard to corrosion and oxidation.

This protective layer is characteristically composed, in all or part, of hydrocarbon chains R bonded to the surface of the particles (p) via [particle]-Al—O—Si—R bonds. The protective layer of the particles (p) can comprise, in certain specific cases, organic chains non-covalently bonded to the particles, in particular chains complex to the surface of the particles or bonded to their surface by an ionic bond or alternatively by a hydrogen bond. In certain specific cases, the protective layer can also comprise elements of a nonorganic nature. However, the chains covalently bonded to the particles (p) are generally predominant in the layer.

Thus, as a general rule, the mean amount of hydrocarbon chains R which are bonded to the surface of the particles (p) via [particle]-Al—O—Si—R bonds remains greater than or equal to 10 micromol per m² of surface area of pigments, this amount preferably being at least equal to 12 micromol per m² and advantageously at least equal to 14 micromol per m² and preferably of the order of 16 micromol per m².

Furthermore, the protective layer of the particles (p) is generally absolutely free from fatty acid. More generally, the compositions of the invention are, as a general rule, devoid of the presence of any fatty acid or fatty acid salt.

Preferably, the protective layer is essentially composed of hydrocarbon chains R bonded to the surface of the particles (p) via [particle]-Al—O—Si—R bonds. According to an especially advantageous embodiment, the protective layer can have the form of a polymer “shell” forming a continuous protective film around the particles (p) which has the diagrammatic structure represented in FIG. 1 below:

[image]

The constituent hydrocarbon chains R of the protective layer, which are bonded to the surface of the particles (p) via [particle]-Al—O—Si—R bonds, are preferably chosen from:
linear or nonlinear alkyl chains comprising from 1 to 30 carbon atoms and advantageously between 8 and 18 carbon atoms. In this context, methyl, ethyl, propyl, isopropyl, butyl, pentyl, hexyl, heptyl, octyl, decyl, dodecyl, hexadecyl, octadecyl, cosyl, heptacosyl and triacontyl chains are especially suitable according to the invention, the octadecyl, octyl, decyl, dodecyl and hexadecyl chains being more particularly preferred;
linear or nonlinear alkyl chains comprising from 1 to 30 carbon atoms and preferably between 8 and 18 carbon atoms which are completely or partially fluorinated and optionally hydroxylated. In this context, the chains comprising (or composed of) fluoromethyl, trifluoromethyl, trifluoropropyl, heptadecafluorotetrahydrodecyl, heptafluoroisopropoxypropyl and tridecafluorotetrahydrooctyl groups are especially preferred;
linear or nonlinear alkenyl or alkynyl chains comprising from 1 to 30 carbon atoms and preferably between 8 and 18 carbon atoms and preferably chains comprising vinyl, allyl, hexenyl, octenyl, undecenyl and docosenyl groups;
cyclic, preferably aromatic, optionally halogenated, hydrocarbon chains comprising between 6 and 30 carbon atoms, such as the benzyl, phenyl, phenethyl, styryl, tolyl, bromobenzyl, chlorobenzyl, fluorophenyl, chlorophenyl or iodophenyl groups;
linear or nonlinear hydrocarbon chains comprising from 1 to 30 carbon atoms (preferably between 8 and 18 carbon atoms) and substituted by at least one amine functional group and in particular the aminopropyl, aminobutyl, aminophenyl, aminoethylaminopropyl and diethylenetriaminepropyl groups;
hydrocarbon chains comprising from 3 to 30 carbon atoms and comprising polymerizable groups, such as epoxyhexyl, epoxypropoxypropyl, methacryloyloxymethyl or methacryloyloxypropyl chains.

Due to the especially good stability of the particles (p) with regard to oxidation and corrosion, the compositions of the invention can generally be provided in various forms.

Thus, the compositions according to the invention can, for example, be provided in the form of a powder comprising the particles (p) in the dry state, this powder being redispersible in water or else in an organic solvent (polar or nonpolar solvents, such as hydrocarbon mixtures, glycols or alternatively alcohols) or else in a polymer matrix (in particular in a matrix based on polystyrene, poly(vinyl chloride), polyurethane, polyester or polyalkyd or on a polyacrylic or polymethacrylic polymer).

Especially, it should be stressed that the pigment compositions of the invention can be provided in the form of dispersions comprising the particles (p) in an aqueous medium. The compositions of the invention can also have the form of dispersions comprising the particles (p) in a solvent medium (polar or nonpolar solvent, in particular hydrocarbon mixtures, glycols or alcohols). When the compositions of the invention are provided in the form of dispersions in an aqueous medium or in a solvent medium, their concentration of particles (p) may generally vary between 25 and 90% by weight, this concentration being preferably between 50 and 75% by weight.

According to another aspect, the present invention also relates to a process for the preparation of the pigment compositions as defined above.

This process is characterized in that it comprises a stage (E) which consists in deforming under mechanical stress, particles (p₀) based on aluminum metal in the presence of the following compounds:
(i) silanes corresponding the following formula (I): 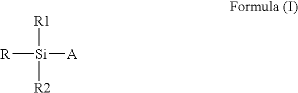
   wherein:
   R represents a hydrocarbon chain as defined above;
   A denotes a hydrolyzable group; and
   R1 and R2, which are identical or different, each represent:
      a hydrolyzable group which is or is not identical to the group A (preferably identical to the group A, if appropriate);
      a hydrocarbon chain which is or is not identical to the chain R (preferably identical to the chain R, if appropriate);
      a group of formula (II): 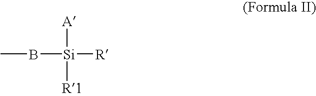
   wherein:
   B is a hydrocarbon chain optionally interrupted by oxygen atoms and which generally has between 1 and 10 carbon atoms, this chain preferably being a poly(propylene oxide) chain or a nonyl, heptyl, octyl, hexyl, pentyl, butyl, propyl, ethyl or methyl chain;
   A′ has one of the meanings given above for A;
   R′ has one of the meanings given above for R;
   R′1 denotes a hydrolyzable group which is or is not identical to the group A′ (and preferably identical to the group A′, if appropriate) or else a hydrocarbon chain which is or is not identical to the group R′ (and preferably identical to the group R′, if appropriate);
(ii) water, at least in the form of traces, this water generally being contributed by the water naturally absorbed at the surface of the aluminum particles (p₀), and;
(iii) an organic solvent.

The deformation under mechanical stress carried out in stage (E) aims at deforming the particles (p₀).

Advantageously, this deformation under mechanical stress of the particles (p₀) is carried out in a mill, generally in a ball mill, in the presence of compounds (i), (ii) and optionally (iii).

As emphasized above, the inventors have demonstrated that the conditions to be employed in stage (E) of the process of the invention can be modeled on the conventional conditions for carrying out the Hall process, the fatty acid generally used being replaced by a compound of formula (I). Thus, the processing conditions of stage (E) can in particular be those disclosed in patents U.S. Pat. No. 3,901,688, U.S. Pat. No. 3,970,577, U.S. Pat. No. 3,901,688, U.S. Pat. No. 4,236,934 or U.S. Pat. No. 4,693,754 or in application EP 305 158.

According to specific alternative form, which may prove to be advantageous, stage (E) of the process of the invention can comprise a preliminary stage consisting of subjecting the particles (p₀), in suspension in solvent (iii), to deformation under mechanical stress (generally in a ball mill), this stage being followed by a second stage consisting in continuing the deformation of the particles (p₀) under mechanical stress in the presence of all the constituents (i), (ii) and (iii). Alternatively, stage (E) of the process of the invention can also be carried out by simultaneously introducing all the various constituents (i), (ii) and (iii) from the beginning of the process for deformation under mechanical stress.

Independently from any specific theory, it appears possible to hypothesize that, while the processing conditions of stage (E) are similar overall to those of the Hall process, the mechanisms involved during the mechanical deformation appear for their part to be very different. Thus, in the process of the invention, the compounds of formula (I) appear to play a role as lubricant analogous to the fatty acids of the Hall process but a true chemical reaction occurs at the surface of the aluminum particles and not a simple adsorption phenomenon as in the case of the Hall process. On the basis of these facts, the process of the invention may be defined as a mechanical/chemical process simultaneously bringing about (1) deformation of the aluminum powder and (2) a reaction in which Al—O—Si—R covalent bonds are formed at the surface of the particles in the course of deformation.

The particles (p₀) employed in stage (E) are particles based on aluminum metal preferably comprising at least 99% by weight, advantageously at least 99.5% by weight (and more preferentially at least 99.7%, indeed even 99.9%, by weight) of aluminum metal. These particles (p₀) advantageously exhibit a mean initial size of between 0.1 and 100 μm, this mean size of the initial particles (p₀) advantageously being at least equal to 1 μm and preferably at least equal to 3 μm, it being understood that it is preferable for this initial particle size to remain less than 50 μm and preferably less than 30 μm. As regards the mean initial dimensions of the particles (p₀), a “d₅₀” limiting size is generally defined which is such that 50% of the particles of the population of the particles (p₀) exhibit a size which is less than this limiting size d₅₀. Likewise, two other reference limiting sizes, referred to respectively as “d₁₀” and “d₉₀”, may be defined which denote the limiting sizes such that 10% (respectively 90%) of the particles of the population of the particles (p₀) exhibit a size which is less than this limiting size d₁₀ (respectively d₉₀).

Particles (p₀) which are employed in stage (E) are advantageously particles of pulverulent aluminum metal obtained by atomization, that is to say by cooling liquid aluminum sprayed, for example, into a stream of inert gas or into a steam of air. Thus, the particles (p₀) can in particular be particles of the type of those sold by Toyal Europe S. A., Toyal America Inc. and Toyo Aluminium K.K. under the name of “Grade 406S”, “Grade 409S” or “Grade 432”.

According to a specific embodiment of the invention, the particles (p₀) can be particles which have been grafted beforehand with organic chains, in particular with organic chains of the type of the chains R present on the silanes, it being possible for these grafted particles, for example, to be obtained by a preliminary treatment of the aluminum particles (in particular Grades “406S”, “409S” or “432” as mentioned above) with a silane of formula (I) in the presence of traces of water, the water naturally adsorbed at the surface of the aluminum particles generally being sufficient in this context.

The silane compounds of formula (I) employed in stage (E) of the process of the invention characteristically comprise at least one hydrolyzable group A.

The term “hydrolyzable group” is understood to mean, within the meaning of the present description, a group capable of reacting in the presence of water or of traces of water to form an —OH group. Preferably, in the silanes of formula (I) employed in stage (E), the hydrolyzable groups present (namely the group A and optionally the group R1 and/or the group R2 and/or the group R′1, if appropriate) are chosen from chloro (—Cl), alkoxyl (preferably C₁ to C₆ alkoxyl groups) and aryloxyl (generally aryloxyl groups comprising from 6 to 12 carbon atoms) groups, these hydrolyzable groups preferably being chosen from the chloro, methoxyl, ethoxyl, isopropoxyl, N-butyoxyl or phenoxyl groups.

In the case where one of the hydrolyzable groups present on the silane is a chloro group, it should be noted that the hydrolysis results in evolution of hydrochloric acid, which it is generally necessary to trap by addition of amine. Consequently, functional groups of alkoxyl and aryloxyl type are preferred. It is thus preferable, as a general rule, for the hydrolyzable groups of the compounds of formula (I) to be compounds of alkoxyl and aryloxyl type.

Generally, the silanes of formula (I) employed in stage (E) of the process of the invention are monofunctional silanes, that is to say silanes comprising a single hydrocarbon chain (namely the R group) and where the R1 and R2 groups are hydrolyzable groups (generally alkoxyl or aryloxyl groups). This is because the use of such silanes makes it possible to generally obtain, in fine, by homopolymerization of the silane groups, protective layers of polymer shell type around the particles, such as those which are which are represented diagrammatically on FIG. 1.

However, it may be advantageous that the silanes employed in stage (E) have two or three hydrocarbon chains, that is to say for the R1 group and/or the R2 group to represent a hydrocarbon chain as defined above. In this case, it is preferable, however, for the hydrocarbon chains present to be chains exhibiting a relatively low number of carbon atoms, namely preferably less than 10 carbon atoms and advantageously less than 5 carbon atoms, these chains being particularly preferably methyl or ethyl groups.

When one of the groups R1 or R2 denotes a hydrocarbon-silane group of formula (II), it is preferable for the other of the groups R2 or R1 to denote a hydrolyzable group or a hydrocarbon chain identical to or different from the chain R. In the formula (II), the group R′1 preferably denotes a hydrolyzable group.

As a general rule, in the process of the invention, the amount of silane of formula (I) employed in stage (E) is preferably at least equal to 40 g per kg of aluminum, this amount generally being less than or equal to 400 g per kg of aluminum.

The solvent (iii) employed in stage (E) of the process of the invention is generally a solvent which protects the particles from moisture. In this context, it is thus generally preferable for the solvent (iii) to be a hydrophobic solvent, advantageously a nonpolar hydrophobic solvent. Furthermore, the solvent (iii) is generally chosen so as to carry out the milling under optimum safety conditions and it is preferable in particular in this context for this solvent to have a flash point which is as high as possible. Furthermore, it is advantageous, in particular in order to limit losses of solvent by evaporation (which can be sources of fire), for the solvent (iii) to have a volatility which is as low as possible. Furthermore, it is preferable for this solvent to be able to be easily removed on conclusion of the process. Thus, the solvent (iii) can advantageously be chosen from mixtures of hydrocarbons, such as mixtures of aliphatic hydrocarbons, such as mixtures of white spirit type, and/or mixtures of aromatic hydrocarbons, such as xylene.

Generally, whatever its nature, the amount of organic solvent (iii) employed in stage (E) is between 1 and 10 kg per kg of aluminum, this amount preferably being greater than or equal to 2 kg per kg of aluminum and advantageously remaining less than or equal to 8 kg per kg of aluminum.

Furthermore, stage (E) of the process of the invention is generally carried out at a temperature of between 10 and 80° C., this temperature preferably being at least equal to 20° C. and preferably less than or equal to 50° C. Furthermore, it may be advantageous to carry out stage (E) under an atmosphere of inert gas (nitrogen or argon, for example). However, in the general case, use of such an inert gas is not essential.

The process of the invention generally comprises, following stage (E), a maturing stage which generally consists in leaving the medium standing for a time generally at least equal to 24 hours, preferably at a temperature of greater than or equal to 20° C. and advantageously at a temperature of between 40 and 60° C. According to a specific alternative form, the process of the invention can comprise, following stage (E) and the optional additional maturing stage, an additional stage of removal of the solvent, by which means a composition in the form of a powder is obtained. This powder can subsequently be dispersed in an aqueous or organic solvent phase, by which means a composition in the form of a dispersion, respectively an aqueous or organic dispersion, is obtained.

According to another embodiment of the present invention, the pigment compositions defined above can also be obtained according to a second preparation process comprising a stage similar to stage (E) defined above but carried out in the absence of organic solvent and under an inert gas atmosphere (argon or nitrogen, for example).

This second preparation process generally comprises a stage (E′) which consists in deforming, under mechanical stress and under an inert gas atmosphere, particles (p′₀) based on aluminum metal in the presence of the following compounds:
(i′) silanes corresponding to the general formula (I) as defined above, and
(ii′) water, at least in the form of traces, this water generally being contributed by the water naturally adsorbed at the surface of the aluminum particles (p₀).

This stage (E′) is generally a cold stamping stage of the type of that employed in the known process under the name “Bessemer” process. Consequently, stage (E′) generally consists in placing the particles of the type (p′₀) on a steel anvil and in deforming these particles under the action of hammers in the presence of silanes (i′).

The particles (p′₀) employed in stage (E′) can, in the general case, be as defined above for the particles (p₀). It is thus preferable for these particles to be particles based on aluminum metal preferably comprising at least 99.7% by weight and more preferentially 99.9% by weight of aluminum metal, these particles advantageously exhibiting a mean initial size of between 0.1 and 100 microns.

The silanes employed in stage (E′) can be chosen from any silane of the formula (I) as employed in stage (E) defined above.

Furthermore, stage (E′) of the second process of the invention is generally carried out at a temperature of between 10 and 80° C. The inert gas employed in this stage can in particular be nitrogen, argon or a mixture of these two gases.

Whatever their method of preparation, the pigment compositions of the invention can be employed in numerous fields of application, in particular taking into account their resistance to corrosion and to oxidation. Especially, the compositions according to the invention can, for example, be used for the formulation of metallic paints, in particular for metallic paints used in the field of the automobile industry, or alternatively for industrial paints, it being possible for these paints to be water-based paints. The compositions of the invention can also be used to formulate printing inks with a metallic appearance or alternatively plastics with a metallic appearance. These various uses constitute another specific subject matter of the present invention.

Metallic paint compositions comprising a composition according to the invention and especially compositions comprising water-based metallic paints also constitute a specific subject matter of the present invention, as well as printing inks with a metallic appearance and plastics with a metallic appearance incorporating pigment compositions according to the invention.

Characteristics and various advantages of the invention will be even more apparent in the light of the illustrative examples set out below.

### EXAMPLE 1

### Preparation of a Pigment Composition According to the Invention

32 kg of steel balls with a diameter of 2 mm were introduced into a horizontal cylindrical mill equipped with baffle bars with an internal diameter of 500 mm and an internal depth of 200 mm. 800 g of aluminum powder (d₁₀=4 μm, d₅₀=11 μm and d₉₀=19 μm), obtained by atomization (aluminum sold by Toyal Europe S.A.), and 2800 g of white spirit (Pétrosol 15A/15-20 sold by Cepsa) was subsequently introduced into this mill. The mixture of aluminum and of white spirit was subjected to 30 min of milling at 24 revolutions per minute, following which a dispersion of 80 g of octadecyltrimethoxysilane in 2700 g of white spirit was added to the mill. Milling was continued at 24 revolutions per minute for 8 hours.

It should be noted that the aluminum powder used in this example naturally comprises traces of water adsorbed at its surface, which is sufficient to make possible the hydrolysis of the silane molecules introduced.

On conclusion of the milling, a slurry was obtained and was subjected to sieving through a 38-micron sieve and then through a 25-micron sieve. The paste, thus sieved, was subsequently subjected to vacuum filtration, so as to obtain a pigment paste, the nonvolatile material level of which was brought to 65° C. by mixing the pigment paste in the presence of the necessary amount of white spirit.

The paste obtained was subsequently subjected to a maturing stage at a temperature of 50° C. for 15 days.

### EXAMPLE 2

### Preparation of a Pigment Composition According to the Invention

800 g of aluminum powder, such as that used in example 1 (d₁₀=4 μm, d₅₀=11 μm and d₉₀=19 μm), 2800 g of white spirit (Pétrosol 15A/15-20 sold by Cepsa) and 4 g of 1,2-bis(triethoxysilyl)ethane were introduced into the mill of example 1 filled with 32 kg of steel balls with a diameter of 2 mm. The mixture was subjected to 30 min of milling at 24 revolutions per minute, following which a dispersion of 80 g of octadecyltrimethoxysilane in 2700 g of white spirit was added to the mill. Milling was continued at 24 revolutions per minute for 8 hours.

On conclusion of the milling, a slurry was obtained which was subjected to sieving through a 38 μm sieve and then through a 25 μm sieve. The paste, sieved twice, was subsequently subjected to vacuum filtration, so as to obtain a pigment paste, the nonvolatile material level of which was brought to 65% by mixing the pigment paste in the presence of the necessary amount of white spirit.

The paste was subsequently subjected to a maturing stage at a temperature of 50° C. for 15 days.

### EXAMPLE 3

### Test of Resistance to Corrosion in an Aqueous Medium

The mature pigment paste obtained on conclusion of example 1 was subjected to a “gassing” test, which consisted in formulating the pigments in an aqueous-phase paint system (the pigments are introduced in the proportion of a concentration of aluminum metal of 4% into a waterborne polyester paint composition with a pH of between 7.8 and 8.2) and in then determining the amount of hydrogen produced by corrosion of the aluminum pigments in this formulation. The “gassing” test carried out was carried out at 40° C.

By way of comparison, the same “gassing” test was carried out on the same weight of conventional pigments obtained by milling in the presence of oleic acid according to the Hall process under identical conditions (powder, mill, balls, temperature, rotational speed, and the like). The volume of hydrogen given off during the “gassing” test carried out on the pigments of the invention does not exceed 4 ml, even after 50 hours, whereas, for the conventional pigments, the volume of hydrogen given off exceeds 6 ml after 4 hours, this volume being greater than 20 ml after 6 hours. This example clearly illustrates the resistance to corrosion of the pigment compositions of the invention, a resistance which is much greater than that of the Hall pigments.

### EXAMPLE 4

### Colorimetric Characteristics

The two pigment pastes tested in example 3 were also analyzed from the viewpoint of their calorimetric characteristics on an X-Rite MA68 calorimeter, after formulation in a solvent-based paint system (in a proportion of concentration of aluminum metal of 5% in a paint of polyacrylic type).

The characteristics of the matured composition of example 1 and of the composition of Hall type are listed in table 1 below.

TABLE 1
Colorimetric characteristics of a composition according to the
invention compared with a normal composition of Hall type

| | Matured composition | Composition of |
|---|---|---|
| | of example 1 | Hall type |
| L* 15° | 137.09 | 139.82 |
| L* 25° | 108.68 | 108.18 |
| L* 45° | 64.48 | 62.27 |
| L* 75° | 38.87 | 37.95 |
| L* 110° | 32.77 | 32.71 |
| Flop index | 13.0 | 13.7 |

1-23. (canceled)

24. A pigment composition comprising particles (p) based on aluminum metal, said particles (p) having a surface oxidation layer with a mean thickness at most equal to 5 nm and said particles (p) being covered with a protective layer comprising hydrocarbon chains R bonded to the surface of the particles (p) via [particle]-Al—O—Si—R bonds.

25. The composition of claim 24, wherein the particles (p) are anisotropic particles with mean dimensions of less than or equal to 500 microns.

26. The composition of claim 24, wherein the particles (p) are flakes with a mean transverse diameter of less than or equal to 500 microns and with a mean thickness of less than or equal to 3 microns.

27. The composition of claim 26, wherein the aspect ratio of the particles (p) (ratio of the mean thickness to the mean transverse diameter) is between ⅕ and 1/1000.

28. The composition of claim 24, wherein the specific surface of the particles (p) is between 0.5 and 500 m²/g.

29. The composition of claim 24, wherein the hydrocarbon chains R are selected from the group consisting of:
alkyl chains comprising from 1 to 30 carbon atoms;
alkyl chains which are completely or partially fluorinated and optionally hydroxylated comprising from 1 to 30 carbon atoms;
alkenyl or alkynyl chains comprising from 1 to 30 carbon atoms;
cyclic, aromatic, optionally halogenated,
hydrocarbon chains comprising between 6 and 30 carbon atoms;
hydrocarbon chains comprising from 1 to 30 carbon atoms which are substituted by at least one amine functional group;
hydrocarbon chains comprising from 3 to 30 carbon atoms and comprising polymerizable groups.

30. The composition of claim 24, wherein the mean amount of hydrocarbon chains R bonded to the surface of the particles (p) is of at least 10 micromol per m².

31. The composition of claim 24, which is in the form of a powder comprising the particles (p) in the dry state, or in the form of a dispersion comprising the particles (p) in an aqueous medium, or in the form of a dispersion comprising the particles (p) in a solvent medium.

32. The composition of claim 24, which is devoid of the presence of any fatty acid or fatty acid salt.

33. A process for the preparation of the composition of claim 24, which comprises a stage (E) consisting in deforming, under mechanical stress, particles (p₀) based on aluminum metal in the presence of the following compounds:
(i) silanes having the following formula (I): 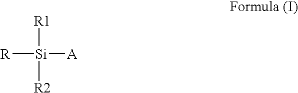
wherein:
R represents a hydrocarbon chain;
A denotes a hydrolyzable group; and
R1 and R2, are identical or different, and each represent:
a hydrolyzable group which is or is not identical to the group A;
a hydrocarbon chain which is or is not identical to the chain R; or
a group of formula (II): 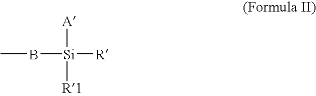
wherein:
B is a hydrocarbon chain optionally interrupted by oxygen atoms;
A′ has one of the meanings given above for A;
R′ has one of the meanings given above for R;
R′1 denotes a hydrolyzable group or a hydrocarbon chain;
(ii) water, at least in the form of traces.

34. The process of claim 33, wherein stage (E) is carryied out in the further presence of (iii) an organic solvent.

35. The process of claim 33, wherein the particles (p₀) employed in stage (E) exhibit an initial particle size of between 0.1 and 100 microns.

36. The process of claim 33, wherein the particles (p₀) which are employed in stage (E) are particles which have been grafted beforehand with organic chains.

37. The process of claim 33, wherein, in the silanes of formula (I), the hydrolyzable groups are chosen from the group consisting of chloro, alkyloxyl and aryloxyl groups.

38. The process of claim 33, wherein the amount of silanes (I) employed in stage (E) is of at least 40 g per kg of aluminum.

39. The process of claim 33, wherein the solvent (iii) employed in stage (E) is chosen from the group consisting of mixtures of aliphatic hydrocarbons, mixtures of aromatic hydrocarbons, and mixtures thereof.

40. The process of claim 33, wherein the amount of organic solvent (iii) employed in stage (E) is of between 1 and 10 kg per kg of aluminum.

41. The process of claim 33, wherein stage (E) is carried out at a temperature of between 10 and 80° C.

42. The process of claim 33, which further comprises, following stage (E), a maturing stage which consists in leaving the medium standing for at least 24 hours at a temperature of greater than or equal to 20° C.

43. The process of claim 33, which further comprises, following stage (E), a stage of removal of the solvent, whereby a composition in the form of a powder is obtained, which composition can subsequently be optionally dispersed in a solvent phase, whereby a composition in the form of a dispersion is obtained.

44. A process for the preparation of the composition of claim 24, which comprises the stage (E′) consisting in deforming, under mechanical stress, particles (p′₀) based on aluminum metal under an inert gas atmosphere in the presence of the following compounds:
(i′) silanes corresponding to the general formula (I); and
(ii′) water, at least in the form of traces.

45. A method making use of the composition of claim 24, for the formulation of a metallic paint, of a printing ink with a metallic appearance or of a plastic with a metallic appearance.

46. A metallic paint composition comprising the composition of claim 24.
